(19) United States
(12) Patent Application Publication
(10) Pub. No.: US 2026/0291672 A1
(43) Pub. Date: Sep. 24, 2026

(54) METHOD AND APPARATUS FOR DETERMINING UPLINK TRANSMISSION IN MOBILE COMMUNICATIONS

(71) Applicant: MEDIATEK SINGAPORE PTE. LTD., Singapore (SG)

(72) Inventors: Jozsef Gabor NEMETH, Cambridge (GB); Mohammed S Aleabe AL-IMARI, Cambridge (GB); Sylvio Paul Mathieu BARDES, Cambridge (GB); Pradeep JOSE, Cambridge (GB)

(73) Assignee: MEDIATEK SINGAPORE PTE. LTD., Singapore (SG)

(21) Appl. No.: 19/475,403

(22) PCT Filed: Oct. 10, 2024
(86) PCT No.: PCT/CN2024/123914

§ 371 Date: Oct. 14, 2025

Related U.S. Application Data
(60) Provisional application No. 63/589,344, filed on Oct. 11, 2023.

(51) Int. Cl. H04L 5/00; H04W 72/115

(52) U.S. Cl. CPC H04L 5/0044; H04L 5/0055; H04W 72/115

(57) ABSTRACT

Various solutions for determining uplink (UL) transmission with respect to an apparatus in mobile communications are described. The apparatus may transmit a downlink (DL) information. The DL information may be associated with an UL transmission. The apparatus may receive the UL transmission. In an event that a time span between the DL information and an earliest scheduled UL transmission of a group of time domain overlapped UL transmissions is scheduled to be greater than or equal to a specific time span, a timing of determining the UL transmission of the group of time domain overlapped UL transmissions may be before the specific time span ahead of the earliest scheduled UL transmission. In an event that a time span between the DL information and the UL transmission is scheduled to be less than the specific time span, the UL transmission may be scheduled without collision.

### CROSS REFERENCE TO RELATED PATENT APPLICATION(S)

The present disclosure is part of a non-provisional application claiming the priority benefit of U.S. Patent Application No. 63/589,344, filed 11 Oct. 2023, the content of which herein being incorporated by reference in its entirety.

### TECHNICAL FIELD

The present disclosure is generally related to mobile communications and, more particularly, to determining uplink transmission with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, downlink control information (DCI) may include scheduling information for user equipment (UE) to receive or transmit data via scheduled network resources. More specially, based on a downlink (DL) DCI, the UE may receive a physical downlink shared channel (PDSCH) from the network node after k0 slot(s) which is (are) configured between the DL DCI and the PDSCH, and transmit a physical uplink control channel (PUCCH) (e.g., a PUCCH including HARQ-ACK) to the network node after k1 slot(s) which is (are) configured between the PDSCH and the PUCCH. Furthermore, based on an uplink (UL) DCI, the UE may transmit physical uplink shared channel (PUSCH) to the network node after k2 slot(s) which is (are) configured between the UL DCI and the PUSCH. In addition, from decoding the DL DCI to being ready to receive the PDSCH, N1 symbols represent the required time. From receiving an UL DCI to preparing the PUSCH transmission, N2 symbols represent the required time, which is used to ensure that the UE may have sufficient time to prepare the PUSCH transmission.

In some network scenarios, transmission overrides and transmission arbitrations may occur, and then be affected by various network conditions. For example, in some network scenarios on the same component carrier (CC) or across CCs, after receiving a DCI, the UE determines corresponding PDSCH and PUCCH including HARQ-ACK. Subsequently, the UE receives another DCI and determines corresponding PDSCH and PUCCH including HARQ-ACK, which causes HARQ uplink control information (UCI) reselection. The HARQ UCI delays all possible transmission arbitrations until N1 symbols before the last PUCCH. For another example, in some network scenarios across CCs, after receiving a DCI, the UE determines corresponding PUSCH including HARQ-ACK of PUCCH. Subsequently, the UE receives another DCI and determines corresponding PUSCH including HARQ-ACK of PUCCH. When the PUSCHs are determined overlapped with respect to time domain, PUSCH rate rematching is delayed until some transmission arbitrations (e.g., arbitrations between PUSCHs) are completed. Further, in some network scenarios, a configured grant may be overridden by a dynamic grant (e.g., grant for PUSCH) any time before timeline of N2 symbols starts. However, these compact transmission arbitrations may cause increases

Accordingly, how to mitigate the compact transmission arbitrations becomes an important issue in the newly developed wireless communication network. Therefore, there is a need to provide proper schemes to mitigate the compact transmission arbitrations.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to determining uplink (UL) transmission with respect to apparatus in mobile communications.

In one aspect, a method may involve an apparatus transmitting, a downlink (DL) information. The DL information may be associated with an uplink (UL) transmission. The method may further involve the apparatus receiving the UL transmission. In an event that a time span between the DL information and an earliest scheduled UL transmission of a group of time domain overlapped UL transmissions is scheduled to be greater than or equal to a specific time span, a timing of determining the UL transmission of the group of time domain overlapped UL transmissions may be before the specific time span ahead of the earliest scheduled UL transmission. In an event that a time span between the DL information and the UL transmission is scheduled to be less than the specific time span, the UL transmission may be scheduled without collision. The specific time span may be configured to be greater than a required time span between the DL information and the earliest scheduled UL transmission.

In one aspect, a method may involve an apparatus receiving a DL information. The DL information may be associated with an UL transmission. The method may further involve the apparatus transmitting the UL transmission. In an event that a time span between the DL information and an earliest scheduled UL transmission of a group of time domain overlapped UL transmissions is scheduled to be greater than or equal to a specific time span, a timing of determining the UL transmission of the group of time domain overlapped UL transmissions may be before the specific time span ahead of the earliest scheduled UL transmission. In an event that a time span between the DL information and the UL transmission is scheduled to be less than the specific time span, the UL transmission may be scheduled without collision. The specific time span may be configured to be greater than a required time span between the DL information and the earliest scheduled UL transmission.

In one aspect, an apparatus may comprise a transceiver which, during operation, wirelessly communicates with a wireless network. The apparatus may also comprise a processor communicatively coupled to the transceiver. The processor, during operation, may perform operations comprising transmitting, by the transceiver, a DL information. The DL information may be associated with an UL transmission. The processor may further perform operations comprising receiving the UL transmission. In an event that a time span between the DL information and an earliest scheduled UL transmission of a group of time domain overlapped UL transmissions is scheduled to be greater than or equal to a specific time span, a timing of determining the UL transmission of the group of time domain overlapped UL transmissions may be before the specific time span ahead of the earliest scheduled UL transmission. In an event that a time span between the DL information and the UL transmission is scheduled to be less than the specific time span, the UL transmission may be scheduled without collision. The specific time span may be configured to be greater than a required time span between the DL information and the earliest scheduled UL transmission.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a diagram depicting an example scenario under schemes in accordance with implementations of the present disclosure.

FIG. 9 is a diagram depicting an example scenario under schemes in accordance with implementations of the present disclosure.

FIG. 10 is a diagram depicting an example scenario under schemes in accordance with implementations of the present disclosure.

FIG. 11 is a block diagram of an example communication system in accordance with an implementation of the present disclosure.

FIG. 12 is a flowchart of an example process in accordance with an implementation of the present disclosure.

FIG. 13 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to determining uplink (UL) transmission with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may transmit a downlink (DL) information (e.g., channel state information-reference signal (CSI-RS), downlink control information (DCI) etc.) to a user equipment (UE). After receiving the DL information, the UE may determine an UL transmission (e.g., physical uplink control channel (PUCCH) carrying uplink control information (UCI), or physical uplink shared channel (PUSCH)) associated with the DL information. The UE may transmit the UL transmission to the network node. The network node may receive the UL transmission from the UE.

Further, in the present disclosure, a specific time span may be introduced for determining the UL transmission. In particular, the specific time span may be configured to be greater than a minimum required time span between the DL information and an earliest scheduled UL transmission of a group of time domain overlapped UL transmissions while the minimum required time span includes N2 symbols (defined in 3^{rd} generation partnership project (3GPP) specification). In brief, the specific time span may be configured to be greater than N2 symbols.

In some cases, in an event that a time span between the DL information and the earliest scheduled UL transmission of the group of time domain overlapped UL transmissions is scheduled to be greater than or equal to the specific time span, the UE may determine the UL transmission at a timing before the specific time span ahead of the earliest UL transmission. Furthermore, the UL transmission of the group of time domain overlapped UL transmissions may be scheduled without changing a network resource within the specific time span before the earliest scheduled UL transmission.

In some cases, in an event that a time span between the DL information and the UL transmission is scheduled to be less than the specific time span, the UL transmission may be scheduled without collision, and the UE may determine to transmit the UL transmission.

Therefore, due to the introduction of the specific time span, (1) the timing of determining to transmit the UL transmission may be earlier than N2 symbols or (2) the UL transmission may be transmitted directly without collision, which may enhance the flexibility of determining the UL transmission so that to mitigate the transmission arbitrations.

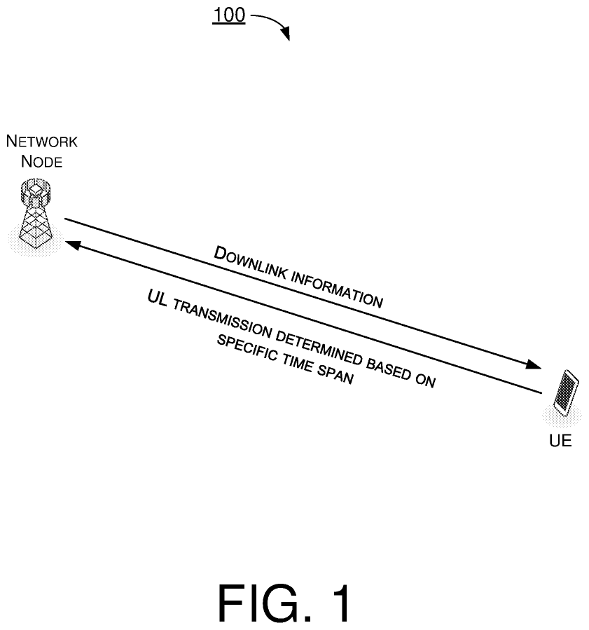

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the network node may transmit a downlink (DL) information (e.g., channel state information-reference signal (CSI-RS), downlink control information (DCI) etc.) to a user equipment (UE). Based on receiving the DL information, the UE may determine an UL transmission (e.g., CSI report, physical uplink control channel (PUCCH) carrying uplink control information (UCI), or physical uplink shared channel (PUSCH)) associated with the DL information. The UE may transmit the UL transmission to the network node. The network node may receive the UL transmission from the UE.

In some implementations, a specific time span may be introduced for determining the UL transmission. In particular, the specific time span may be configured (e.g., by a higher layer configuration such as radio resource control (RRC) configuration)) to be greater than a minimum required time span between the DL information and an earliest scheduled UL transmission of a group of time domain overlapped UL transmissions.

More specifically, when the DL information includes a downlink control information (DCI) and the associated UL transmission is the corresponding PUCCH or PUSCH indicated by the DCI, the minimum required time span between the DL information and the earliest scheduled UL transmission of the group of time domain overlapped UL transmissions may be N2 symbols (defined in 3GPP specification), which is used to ensure that the UE may have sufficient time to prepare the PUCCH or the PUSCH transmission. In brief, the specific time span may be configured to be greater than N2 symbols. Then, depending on different scenarios, the UE may determine how to transmit the UL transmission to the network node based on the specific time span.

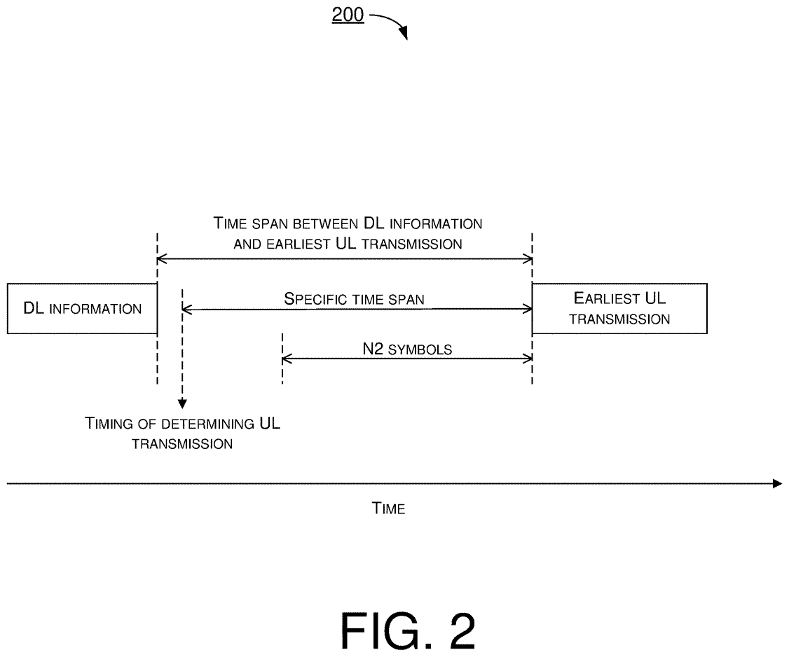

FIG. 2 illustrates an example scenario 200 under schemes in accordance with implementations of the present disclosure. In some cases, in an event that a time span between the DL information and the earliest scheduled UL transmission of the group of time domain overlapped UL transmissions is scheduled to be greater than or equal to the specific time span (which is greater than N2 symbols), the UE may perform an arbitration procedure of determining the UL transmission of the group of time domain overlapped UL transmissions at a timing before the specific time span ahead of the earliest UL transmission, and the UL transmission may be scheduled (e.g., scheduled by the network node and/or the UE) without changing a network resource within the specific time span before the earliest scheduled UL transmission.

In other words, when the scheduled time span between the DL information and the earliest scheduled UL transmission of the group of time domain overlapped UL transmissions is greater than or equal to the specific time span, the UE may arbitrate at the timing to transmit the UL transmission, and the allocation of the network resource for transmitting the UL transmission may be immutable the specific time span before the start of the earliest scheduled UL transmission.

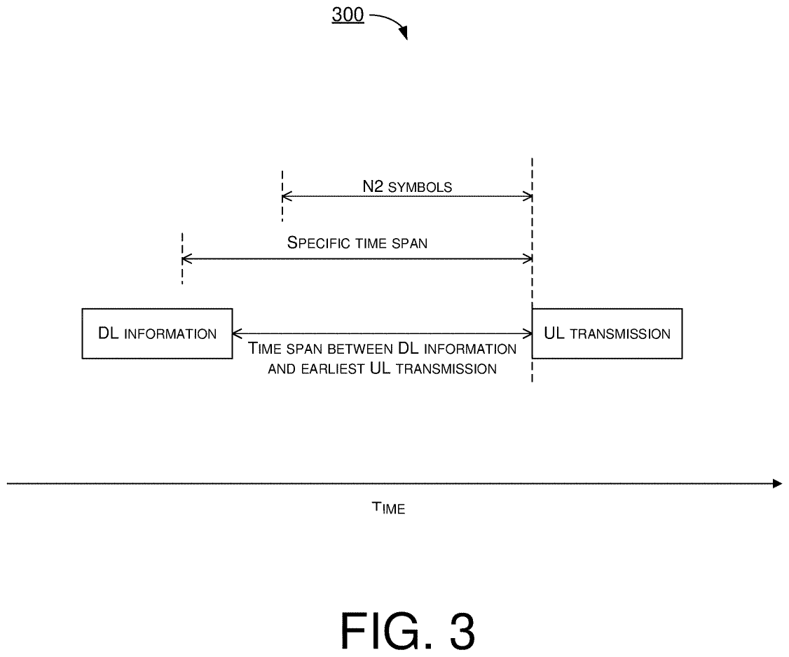

FIG. 3 illustrates an example scenario 300 under schemes in accordance with implementations of the present disclosure. In some cases, in an event that a time span between the DL information and the UL transmission is scheduled to be less than the specific time span (which is greater than N2 symbols), the UL transmission may be scheduled (e.g., scheduled by the network node and/or the UE) without collision, and the UE may determine to transmit the UL transmission without any arbitration procedure.

In other words, when the scheduled time span between the DL information and the UL transmission is less than the specific time span, the UL transmission may be scheduled to be transmitted directly without collision caused by other UL transmission, and the UE may determine to not to perform any arbitration procedure before transmitting the UL transmission.

In some implementations, the specific time span may be applied to dynamic data grant and configured data grant.

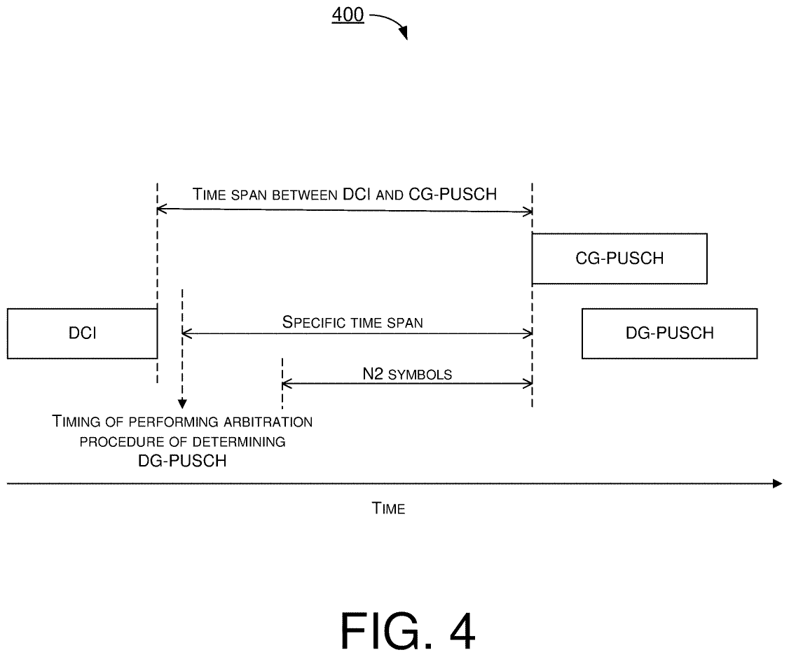

FIG. 4 illustrates an example scenario 400 under schemes in accordance with implementations of the present disclosure. In some cases, the UL transmission may be different from the earliest UL transmission in the group of the time domain overlapped UL transmissions. More specifically, in these cases, the DL information may include a DCI, and the UL transmission of the group of the time domain overlapped UL transmissions may include a dynamic grant-physical uplink shared channel (DG-PUSCH) indicated by the DCI. The earliest UL transmission of the group of the time domain overlapped UL transmissions may include a configured grant-physical uplink shared channel (CG-PUSCH) overlapped with the DG-PUSCH with respect to time domain.

When the time span between the DCI and the CG-PUSCH is scheduled to be greater than or equal to the specific time span (which is greater than N2 symbols), the UE may perform an arbitration procedure of determining the DG-PUSCH at the timing before the specific time span ahead of the CG-PUSCH, and the DG-PUSCH may be scheduled without changing the network resource within the specific time span before the earliest scheduled UL transmission. Based on the arbitration procedure, the UE may then drop the CG-PUSCH and transmit the DG-PUSCH.

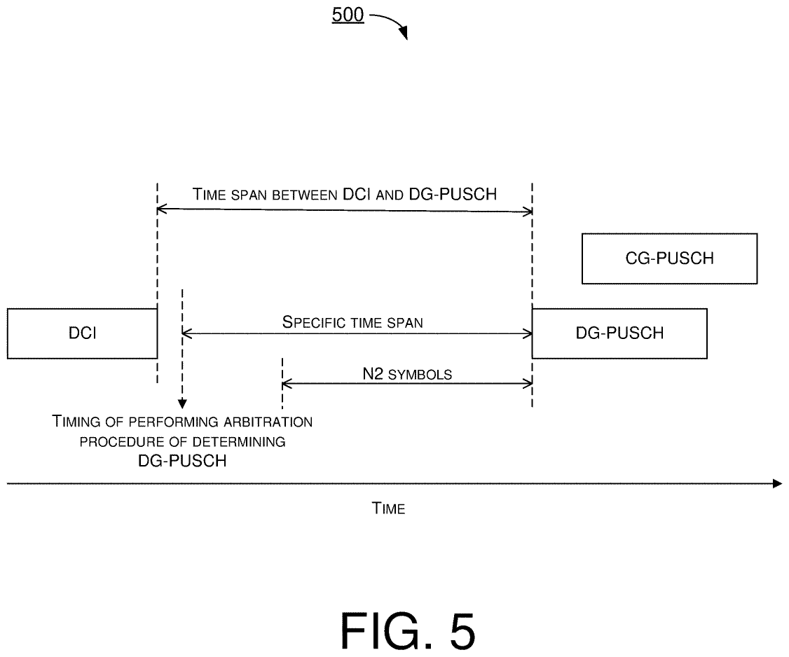

FIG. 5 illustrates an example scenario 500 under schemes in accordance with implementations of the present disclosure. In some cases, the UL transmission may be the earliest UL transmission in the group of the time domain overlapped UL transmissions. More specifically, in these cases, the DL information may include a DCI, and the UL transmission of the group of the time domain overlapped UL transmissions may include a DG-PUSCH indicated by the DCI. The DG-PUSCH may overlap with another UL transmission (e.g., the CG-PUSCH) with respect to time domain.

When the time span between the DCI and the DG-PUSCH is scheduled to be greater than or equal to the specific time span (which is greater than N2 symbols), the UE may perform an arbitration procedure of determining the DG-PUSCH at the timing before the specific time span ahead of the DG-PUSCH, and the DG-PUSCH may be scheduled without changing the network resource within the specific time span before the DG-PUSCH. Based on the arbitration procedure, the UE may then drop the CG-PUSCH and transmit the DG-PUSCH.

In some implementations, the specific time span may be applied to applied to physical uplink control channels (PUCCHs) while each PUCCH may carry hybrid automatic repeat request-acknowledgement (HARQ-ACK), CSI report (e.g., periodic CSI report, semi persistent CSI report or aperiodic CSI report) and/or sounding reference signal (SRS) (e.g., periodic SRS, semi persistent SRS or aperiodic SRS).

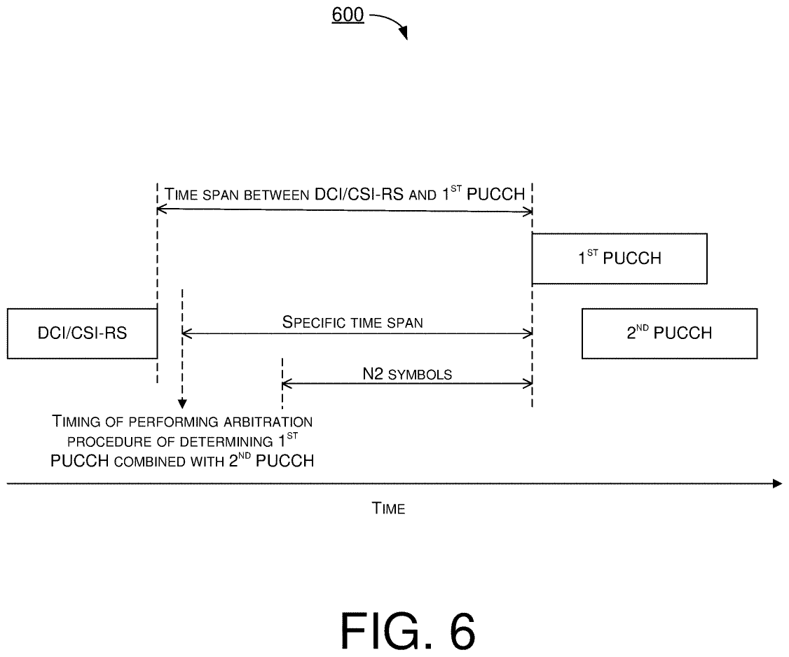

FIG. 6 illustrates an example scenario 600 under schemes in accordance with implementations of the present disclosure. In some cases, the UL transmission may be different from the earliest UL transmission in the group of the time domain overlapped UL transmissions. More specifically, in these cases, the earliest UL transmission of the group of the time domain overlapped UL transmissions may include a first PUCCH. The DL information may include: (1) a DCI indicating a physical downlink share channel (PDSCH), or (2) a CSI-RS, and the UL transmission of the group of the time domain overlapped UL transmissions may include: (1) a second PUCCH carrying HARQ-ACK associated with the PDSCH, or (2) a CSI report. The fist PUCCH and the second PUCCH may overlap with respect to time domain.

When the time span between the DL information (i.e., DCI or CSI-RS) and the first PUCCH is scheduled to be greater than or equal to the specific time span (which is greater than N2 symbols), the UE may perform an arbitration procedure of determining the first PUCCH combined (e.g., multiplexed) with the second PUCCH at the timing before the specific time span ahead of the first PUCCH, and the first PUCCH may be scheduled without changing the network resource within the specific time span before the first PUCCH. In some cases, the first PUCCH may include HARQ-ACK, CSI report or SRS, and the second PUCCH may include HARQ-ACK or CSI report.

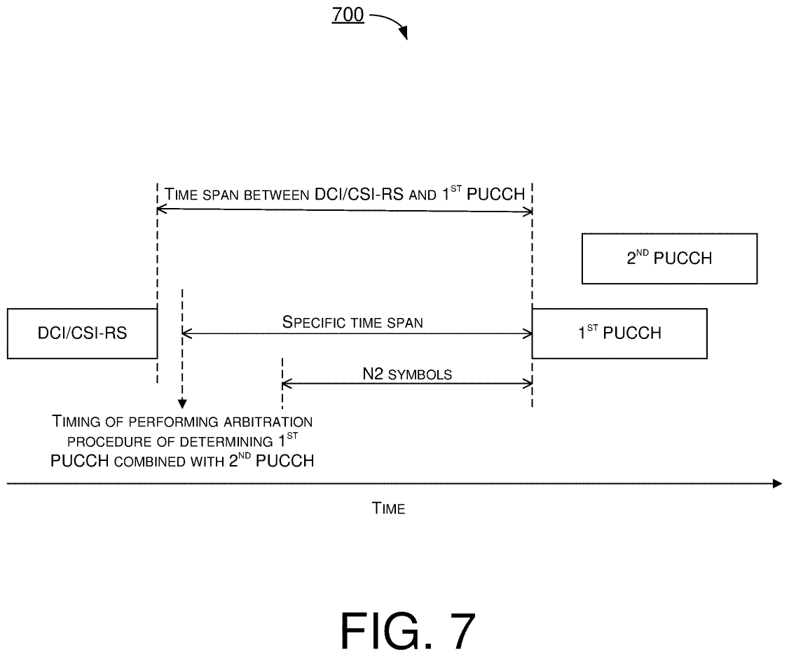

FIG. 7 illustrates an example scenario 700 under schemes in accordance with implementations of the present disclosure. In some cases, the UL transmission may be the earliest UL transmission in the group of the time domain overlapped UL transmissions. More specifically, in these cases, the DL information may include: (1) a DCI indicating a PDSCH, or (2) a CSI-RS, and the UL transmission of the group of the time domain overlapped UL transmissions may include: (1) a first PUCCH carrying HARQ-ACK associated with the PDSCH, or (2) a CSI report. In the group of time domain overlapped UL transmissions, there may be another UL transmission including a second PUCCH. The fist PUCCH and the second PUCCH may overlap with respect to time domain.

When the time span between the DL information (i.e., DCI or CSI-RS) and the first PUCCH is scheduled to be greater than or equal to the specific time span (which is greater than N2 symbols), the UE may perform an arbitration procedure of determining the first PUCCH combined (e.g., multiplexed) with the second PUCCH at the timing before the specific time span ahead of the first PUCCH, and the first PUCCH may be scheduled without changing the network resource within the specific time span before the first PUCCH. In some cases, the first PUCCH may include HARQ-ACK or CSI report, and the second PUCCH may include HARQ-ACK, CSI report or SRS.

It should be noted that, in some cases of applying the specific time span to PUCCHs, the network resource, which may not change, may include at least one of: (1) number of physical resource blocks (PRBs) used in the mapping; (2) symbols duration; (3) index of start symbol (e.g., parameter startSymbolIndex defined in 3GPP specification); (4) PUCCH format; and (5) uplink control information (UCI) coding rate.

In some implementations, the specific time span may be applied to PUSCH and PUCCH.

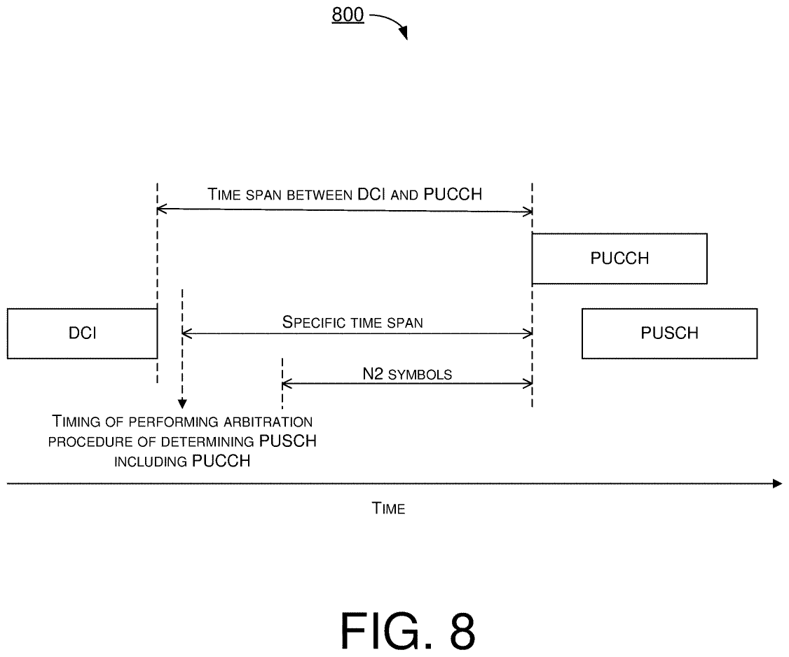

FIG. 8 illustrates an example scenario 800 under schemes in accordance with implementations of the present disclosure. In some cases, the UL transmission may be different from the earliest UL transmission in the group of the time domain overlapped UL transmissions. More specifically, in these cases, the earliest UL transmission of the group of the time domain overlapped UL transmissions may include a PUCCH. The DL information may include a DCI, and the UL transmission of the group of the time domain overlapped UL transmissions may include a PUSCH indicated by the DCI. The PUCCH and the PUSCH may overlap with respect to time domain.

When the time span between the DCI and the PUCCH is scheduled to be greater than or equal to the specific time span (which is greater than N2 symbols), the UE may perform an arbitration procedure of determining the PUSCH including the PUCCH at the timing before the specific time span ahead of the PUCCH, and the PUSCH may be scheduled without changing the network resource within the specific time span before the PUCCH.

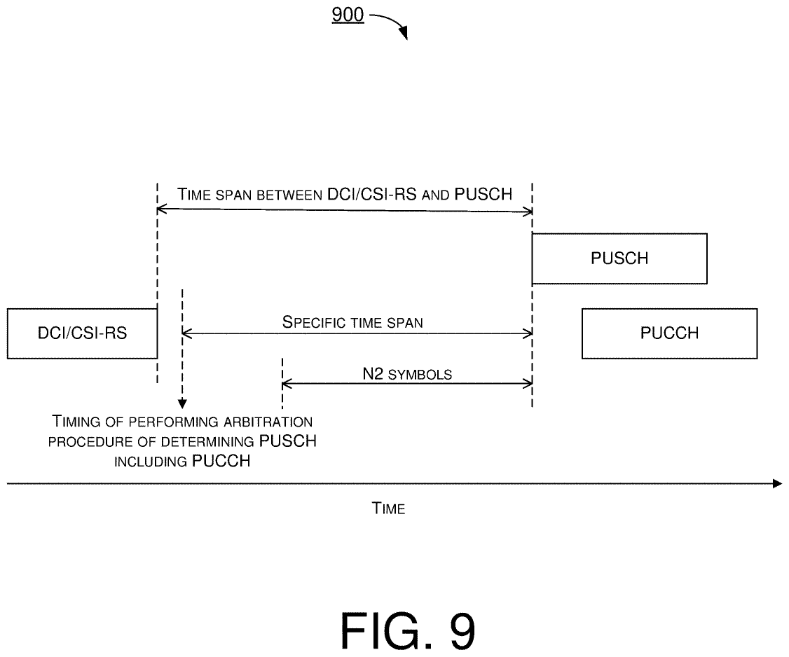

FIG. 9 illustrates an example scenario 900 under schemes in accordance with implementations of the present disclosure. In some cases, the UL transmission may be different from the earliest UL transmission in the group of the time domain overlapped UL transmissions. More specifically, in these cases, the earliest UL transmission of the group of the time domain overlapped UL transmissions may include a PUSCH. The DL information may include: (1) a DCI indicating a PDSCH, or (2) a CSI-RS. The UL transmission of the group of the time domain overlapped UL transmissions may include: (1) a PUCCH associated with the PDSCH, or (2) CSI report. The PUCCH and the PUSCH may overlap with respect to time domain.

When the time span between the DL information (e.g., DCI or CSI-RS) and the PUSCH is scheduled to be greater than or equal to the specific time span (which is greater than N2 symbols), the UE may perform an arbitration procedure of determining the PUSCH including the PUCCH at the timing before the specific time span ahead of the PUCCH, and the PUSCH may be scheduled without changing the network resource within the specific time span before the earliest scheduled UL transmission.

In some implementations, the specific time span may be applied to PUCCH and SRS. In some implementations, the specific time span may be applied to PUSCH and SRS.

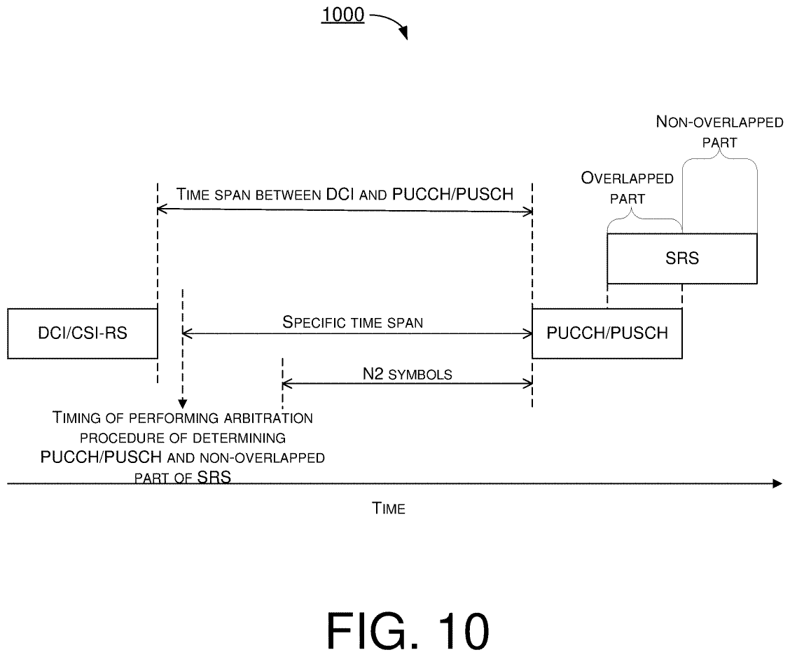

FIG. 10 illustrates an example scenario 1000 under schemes in accordance with implementations of the present disclosure. In some cases, the UL transmission may be the earliest UL transmission in the group of the time domain overlapped UL transmissions. More specifically, in these cases, the DL information may include a DCI or CSI-RS, and the UL transmission of the group of the time domain overlapped UL transmissions may include a PUCCH/PUSCH associated with the DCI/CSI-RS. The PUCCH/PUSCH may overlap with another UL transmission, which may be an SRS, with respect to time domain.

When the time span between the DCI/CSI-RS and the PUCCH/PUSCH is scheduled to be greater than or equal to the specific time span (which is greater than N2 symbols), the UE may perform an arbitration procedure of determining the PUCCH/PUSCH at the timing before the specific time span ahead of the PUCCH/PUSCH, and the PUCCH/PUSCH may be scheduled without changing the network resource within the specific time span before the PUCCH/PUSCH. Based on the arbitration procedure, the UE may then drop overlapped part of the SRS and transmit the non-overlapped part of the SRS following the PUCCH/PUSCH.

It should be noted that, in some cases of applying the specific time span to PUSCH and PUCCH, the coding rate of PUCCH, the coding rate and the payload size of UL transmission may not change after the specific time span starts. In some cases of applying the specific time span to PUSCH and PUCCH, the coding rate and/or the payload size of PUCCH may change before N2 symbols starts during the specific time span, but the coding rate and the payload size of UL transmission may not change after the specific time span starts.

In some implementations, the UL transmission being scheduled without changing the network resource may mean that the UE may not expect certain attributes of physical network resource to change e.g., as a result of resource reselection, multiplexing with other channels or de-prioritization or cancellation. For example, the network resource may, depending on different scenarios, include at least one of: (1) symbols occupied by the UL transmission; (2) physical resource blocks (PRBs) allocated to the UL transmission; (3) available resource elements (REs); (4) PUCCH format; (5) spatial configuration (e.g., quasi co-location (QCL) configuration); (6) demodulation reference signa (DMRS) sequence; and (7) coding rate.

In some implementations, the specific time span may be adjusted by adding some parameters such as d_{2,1} and d₂ (defined in 3GPP specification) related to N2 symbols.

### Illustrative Implementations

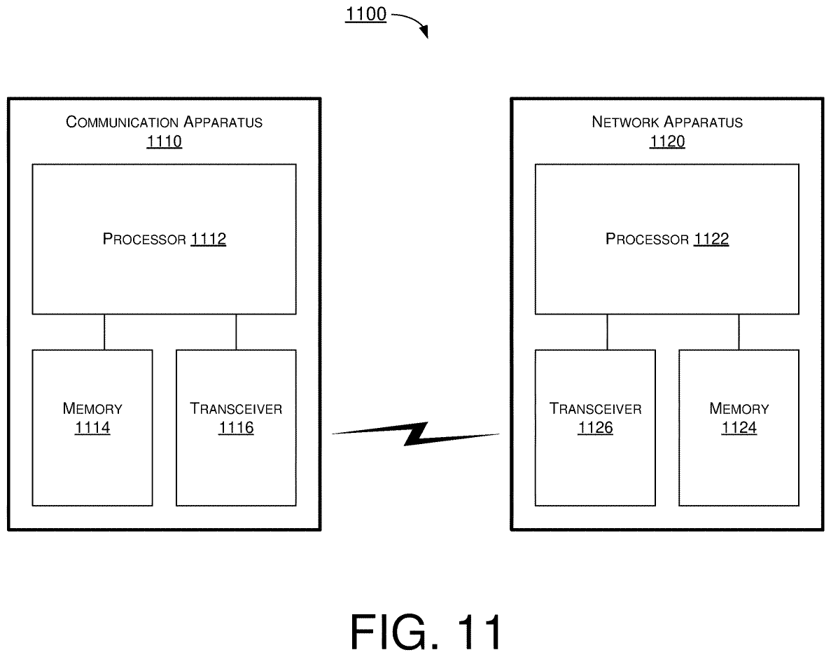

FIG. 11 illustrates an example communication system 400 having an example communication apparatus 1110 and an example network apparatus 1120 in accordance with an implementation of the present disclosure. Each of communication apparatus 1110 and network apparatus 1120 may perform various functions to implement schemes, techniques, processes and methods described herein pertaining to determining UL transmission with respect to UE and network apparatus in mobile communications, including scenarios/schemes described above as well as processes 1200 and 1300 described below.

Communication apparatus 1110 may be a part of an electronic apparatus, which may be a UE such as a portable or mobile apparatus, a wearable apparatus, a wireless communication apparatus or a computing apparatus. For instance, communication apparatus 1110 may be implemented in a smartphone, a smartwatch, a personal digital assistant, a digital camera, or a computing equipment such as a tablet computer, a laptop computer or a notebook computer. Communication apparatus 1110 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1110 may be implemented in a smart thermostat, a smart fridge, a smart door lock, a wireless speaker or a home control center. Alternatively, communication apparatus 1110 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1110 may include at least some of those components shown in FIG. 11 such as a processor 1112, for example. Communication apparatus 1110 may further include one or more other components not pertinent to the proposed scheme of the present disclosure (e.g., internal power supply, display device and/or user interface device), and, thus, such component(s) of communication apparatus 1110 are neither shown in FIG. 11 nor described below in the interest of simplicity and brevity.

Network apparatus 1120 may be a part of a network apparatus, which may be a network node such as a satellite, a base station, a small cell, a router or a gateway. For instance, network apparatus 1120 may be implemented in an eNodeB in an LTE network, in a gNB in a 5G/NR, IoT, NB-IoT or IloT network or in a satellite or base station in a 6G network. Alternatively, network apparatus 1120 may be implemented in the form of one or more IC chips such as, for example and without limitation, one or more single-core processors, one or more multi-core processors, or one or more RISC or CISC processors. Network apparatus 1120 may include at least some of those components shown in FIG. 11 such as a processor 1122, for example. Network apparatus 1120 may further include one or more other components not pertinent to the proposed scheme of the present disclosure (e.g., internal power supply, display device and/or user interface device), and, thus, such component(s) of network apparatus 1120 are neither shown in FIG. 11 nor described below in the interest of simplicity and brevity.

In one aspect, each of processor 1112 and processor 1122 may be implemented in the form of one or more single-core processors, one or more multi-core processors, or one or more CISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including determining UL transmission in a device (e.g., as represented by communication apparatus 1110) and a network (e.g., as represented by network apparatus 1120) in accordance with various implementations of the present disclosure.

In some implementations, communication apparatus 1110 may also include a transceiver 1116 coupled to processor 1112 and capable of wirelessly transmitting and receiving data. In other words, processor 1112 may transceive the data such as configuration, message, signal, information, indicator, etc. via transceiver 1116. In some implementations, communication apparatus 1110 may further include a memory 1114 coupled to processor 1112 and capable of being accessed by processor 1112 and storing data therein. In some implementations, network apparatus 1120 may also include a transceiver 1126 coupled to processor 1122 and capable of wirelessly transmitting and receiving data. In other words, processor 1122 may transceive the data such as configuration, message, signal, information, indicator, etc. via transceiver 1126. In some implementations, network apparatus 1120 may further include a memory 1124 coupled to processor 1122 and capable of being accessed by processor 1122 and storing data therein. Accordingly, communication apparatus 1110 and network apparatus 1120 may wirelessly communicate with each other via transceiver 1116 and transceiver 1126, respectively. To aid better understanding, the following description of the operations, functionalities and capabilities of each of communication apparatus 1110 and network apparatus 1120 is provided in the context of a mobile communication environment in which communication apparatus 1110 is implemented in or as a communication apparatus or a UE and network apparatus 1120 is implemented in or as a network node of a communication network.

In some implementations, each of memory 1114 and memory 1124 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1114 and memory 1124 may include a type of read-only memory (ROM) such as mask ROM, programmable ROM (PROM), erasable programmable ROM (EPROM) and/or electrically erasable programmable ROM (EEPROM). Alternatively, or additionally, each of memory 1114 and memory 1124 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

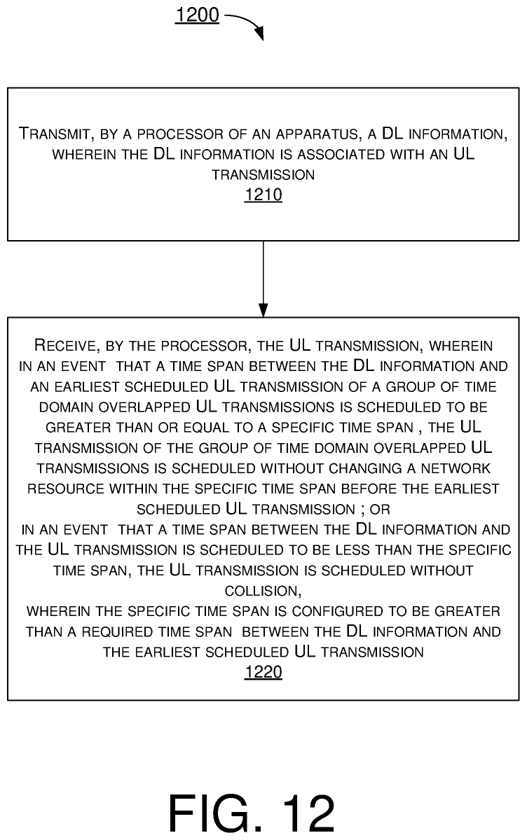

FIG. 12 illustrates an example process 1200 in accordance with an implementation of the present disclosure. Process 1200 may be an example implementation of above scenarios/schemes, whether partially or completely, with respect to determining UL transmission of the present disclosure. Process 1200 may represent an aspect of implementation of features of network apparatus 1120. Process 1200 may include one or more operations, actions, or functions as illustrated by one or more of blocks 1210 to 1220. Although illustrated as discrete blocks, various blocks of process 1200 may be divided into additional blocks, combined into fewer blocks, or eliminated, depending on the desired implementation. Moreover, the blocks of process 1200 may be executed in the order shown in FIG. 12 or, alternatively, in a different order. Process 1200 may be implemented by network apparatus 1120 or any suitable network device or machine type devices. Solely for illustrative purposes and without limitation, process 1200 is described below in the context of network apparatus 1120. Process 1200 may begin at block 1210.

At block 1210, process 1200 may involve processor 1122 of network apparatus 1120 transmitting a DL information. The DL information may be associated with an UL transmission. Process 1200 may proceed from block 1210 to block 1220.

At block 1220, process 1200 may involve processor 1122 of network apparatus 1120 receiving the UL transmission. In an event that a time span between the DL information and an earliest scheduled UL transmission of a group of time domain overlapped UL transmissions is scheduled to be greater than or equal to a specific time span, a timing of determining the UL transmission of the group of time domain overlapped UL transmissions may be before the specific time span ahead of the earliest scheduled UL transmission. In an event that a time span between the DL information and the UL transmission is scheduled to be less than the specific time span, the UL transmission may be scheduled without collision. The specific time span may be configured to be greater than a minimum required time span between the DL information and the earliest scheduled UL transmission.

In some implementations, the UL transmission may be different from the earliest UL transmission. The earliest UL transmission may include a CG-PUSCH. The UL transmission may include a DG-PUSCH.

In some implementations, the UL transmission may be the earliest UL transmission. The UL transmission may include a DG-PUSCH. Another UL transmission of the group of time domain overlapped UL transmissions may include a CG-PUSCH.

In some implementations, the UL transmission may be different from the earliest UL transmission. The earliest UL transmission may include a first PUCCH. The UL transmission may include a second PUCCH. Process 1200 may involve processor 1122 of network apparatus 1120 receiving the first PUCCH combined with the second PUCCH.

In some implementations, the first PUCCH may include HARQ-ACK, CSI report or SRS, and the second PUCCH includes HARQ-ACK or CSI report.

In some implementations, the UL transmission may be the earliest UL transmission. The UL transmission may include a first PUCCH. Another UL transmission of the group of time domain overlapped UL transmissions may include a second PUCCH. Process 1200 may involve processor 1122 of network apparatus 1120 receiving the first PUCCH combined with the second PUCCH.

In some implementations, the first PUCCH includes HARQ-ACK or CSI, and the second PUCCH includes HARQ-ACK, CSI or SRS.

In some implementations, the UL transmission may be different from the earliest UL transmission. The earliest UL transmission may include a PUCCH. The UL transmission may include a PUSCH. Process 1200 may involve processor 1122 of network apparatus 1120 receiving the PUSCH including the PUCCH.

In some implementations, the UL transmission may be different from the earliest UL transmission. The earliest UL transmission may include a PUSCH. The UL transmission may include a PUCCH. Process 1200 may involve processor 1122 of network apparatus 1120 receiving the PUCCH included in the PUSCH.

In some implementations, the network resource may include at least one of: symbols occupied by the UL transmission; PRBs allocated to the UL transmission; available REs; PUCCH format; spatial configuration; DMRS sequence; and coding rate.

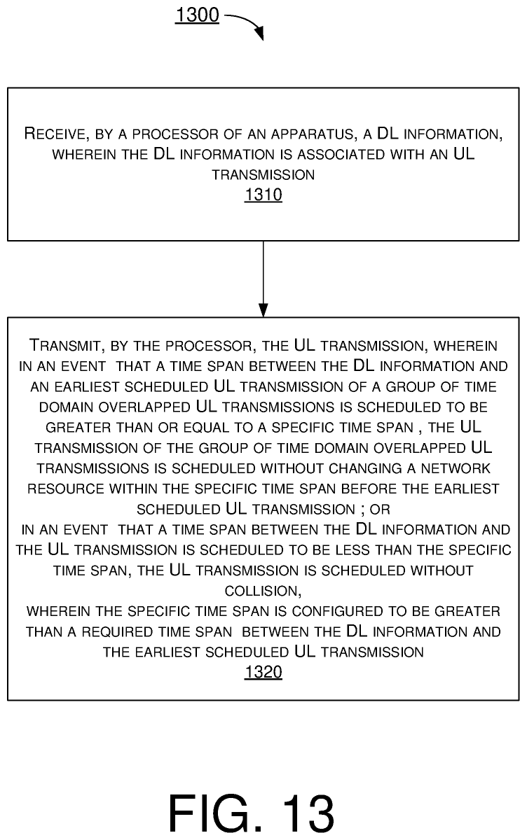

FIG. 13 illustrates an example process 1300 in accordance with an implementation of the present disclosure. Process 1300 may be an example implementation of above scenarios/schemes, whether partially or completely, with respect to determining UL transmission of the present disclosure. Process 1300 may represent an aspect of implementation of features of communication apparatus 1110. Process 1300 may include one or more operations, actions, or functions as illustrated by one or more of blocks 1310 to 1320. Although illustrated as discrete blocks, various blocks of process 1300 may be divided into additional blocks, combined into fewer blocks, or eliminated, depending on the desired implementation. Moreover, the blocks of process 1300 may be executed in the order shown in FIG. 13 or, alternatively, in a different order. Process 1300 may be implemented by communication apparatus 1110 or any suitable UE or machine type devices. Solely for illustrative purposes and without limitation, process 1300 is described below in the context of communication apparatus 1110. Process 1300 may begin at block 1310.

At block 1310, process 1300 may involve processor 1112 of communication apparatus 1110 receiving a DL information. The DL information may be associated with an UL transmission. Process 1300 may proceed from block 1310 to block 1320.

At block 1320, process 1300 may involve processor 1112 of communication apparatus 1110 transmitting the UL transmission. In an event that a time span between the DL information and an earliest scheduled UL transmission of a group of time domain overlapped UL transmissions is scheduled to be greater than or equal to a specific time span, a timing of determining the UL transmission of the group of time domain overlapped UL transmissions may be before the specific time span ahead of the earliest scheduled UL transmission. In an event that a time span between the DL information and the UL transmission is scheduled to be less than the specific time span, the UL transmission may be scheduled without collision. The specific time span may be configured to be greater than a minimum required time span between the DL information and the earliest scheduled UL transmission.

In some implementations, process 1300 may involve processor 1112 of communication apparatus 1110 performing an arbitration procedure of transmitting the UL transmission before the specific time span ahead of the earliest UL transmission in the event that the time span between the DL information and the earliest scheduled UL transmission of the group of time domain overlapped UL transmissions is scheduled to be greater than or equal to the specific time span.

In some implementations, process 500 may involve processor 1112 of communication apparatus 1110 determining to transmit the UL transmission without performing arbitration procedure in the event that the time span between the DL information and the UL transmission is scheduled to be less than the specific time span.

In some implementations, the UL transmission may be different from the earliest UL transmission. The earliest UL transmission may include a CG-PUSCH. The UL transmission may include a DG-PUSCH.

In some implementations, the UL transmission may be the earliest UL transmission. The UL transmission may include a DG-PUSCH. Another UL transmission of the group of time domain overlapped UL transmissions may include a CG-PUSCH.

In some implementations, the UL transmission may be different from the earliest UL transmission. The earliest UL transmission may include a first PUCCH. The UL transmission may include a second PUCCH. Process 1300 may involve processor 1112 of communication apparatus 1110 receiving the first PUCCH combined with the second PUCCH.

In some implementations, the UL transmission may be the earliest UL transmission. The UL transmission may include a first PUCCH. Another UL transmission of the group of time domain overlapped UL transmissions may include a second PUCCH. Process 1300 may involve processor 1112 of communication apparatus 1110 receiving the first PUCCH combined with the second PUCCH.

In some implementations, the UL transmission may be different from the earliest UL transmission. The earliest UL transmission may include a PUCCH. The UL transmission may include a PUSCH. Process 1300 may involve processor 1112 of communication apparatus 1110 receiving the PUSCH including the PUCCH.

In some implementations, the UL transmission may be different from the earliest UL transmission. The earliest UL transmission may include a PUSCH. The UL transmission may include a PUCCH. Process 1300 may involve processor 1112 of communication apparatus 1110 receiving the PUCCH included in the PUSCH.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, a downlink (DL) information, wherein the DL information is associated with an uplink (UL) transmission; and
receiving, by the processor, the UL transmission, wherein
in an event that a time span between the DL information and an earliest scheduled UL transmission of a group of time domain overlapped UL transmissions is scheduled to be greater than or equal to a specific time span, a timing of determining the UL transmission of the group of time domain overlapped UL transmissions is before the specific time span ahead of the earliest scheduled UL transmission; or
in an event that a time span between the DL information and the UL transmission is scheduled to be less than the specific time span, the UL transmission is scheduled without collision,
wherein the specific time span is configured to be greater than a required time span between the DL information and the earliest scheduled UL transmission.

2. The method of claim 1, wherein the UL transmission is different from the earliest UL transmission, the earliest UL transmission includes a configured grant-physical uplink shared channel (CG-PUSCH), and the UL transmission includes a dynamic grant-physical uplink shared channel (DG-PUSCH).

3. The method of claim 1, wherein the UL transmission is the earliest UL transmission, the UL transmission includes a dynamic grant-physical uplink shared channel (DG-PUSCH), another UL transmission of the group of time domain overlapped UL transmissions includes a configured grant-physical uplink shared channel (CG-PUSCH).

4. The method of claim 1, wherein the UL transmission is different from the earliest UL transmission, the earliest UL transmission includes a first physical uplink control channel (PUCCH), the UL transmission includes a second PUCCH, and the step of receiving the UL transmission further includes:
receiving the first PUCCH combined with the second PUCCH.

5. The method of claim 4, wherein the first PUCCH includes hybrid automatic repeat request-acknowledgement (HARQ-ACK), channel state information (CSI) report or sounding reference signal (SRS), and the second PUCCH includes HARQ-ACK or CSI report.

6. The method of claim 1, wherein the UL transmission is the earliest UL transmission, the UL transmission includes a first physical uplink control channel (PUCCH), another UL transmission of the group of time domain overlapped UL transmissions includes a second PUCCH, and the step of receiving the UL transmission further includes:
receiving the first PUCCH combined with the second PUCCH.

7. The method of claim 6, wherein the first PUCCH includes HARQ-ACK or CSI, and the second PUCCH includes HARQ-ACK, CSI or SRS.

8. The method of claim 1, wherein the UL transmission is different from the earliest UL transmission, the earliest UL transmission includes a physical uplink control channel (PUCCH), the UL transmission includes a physical uplink shared channel (PUSCH), and the step of receiving the UL transmission further includes:
receiving the PUSCH including the PUCCH.

9. The method of claim 1, wherein the UL transmission is different from the earliest UL transmission, the earliest UL transmission includes a physical uplink shared channel (PUSCH), the UL transmission includes a physical uplink control channel (PUCCH), and the step of receiving the UL transmission further includes:
receiving the PUCCH included in the PUSCH.

10. The method of claim 1, wherein the network resource includes at least one of:
symbols occupied by the UL transmission;
physical resource blocks (PRBs) allocated to the UL transmission;
available resource elements (REs);
physical uplink control channel (PUCCH) format;
spatial configuration;
demodulation reference signa (DMRS) sequence; and
coding rate.

11. A method, comprising:
receiving, by a processor of an apparatus, a downlink (DL) information, wherein the DL information is associated with an uplink (UL) transmission; and
transmitting, by the processor, the UL transmission, wherein
in an event that a time span between the DL information and an earliest scheduled UL transmission of a group of time domain overlapped UL transmissions is scheduled to be greater than or equal to a specific time span, a timing of determining the UL transmission of the group of time domain overlapped UL transmissions is before the specific time span ahead of the earliest scheduled UL transmission; or
in an event that a time span between the DL information and the UL transmission is scheduled to be less than the specific time span, the UL transmission is scheduled without collision,
wherein the specific time span is configured to be greater than a required time span between the DL information and the earliest scheduled UL transmission.

12. The method of claim 11, further comprising:
performing, by the processor, an arbitration procedure of determining the UL transmission at the timing before the specific time span ahead of the earliest UL transmission in the event that the time span between the DL information and the earliest scheduled UL transmission of the group of time domain overlapped UL transmissions is scheduled to be greater than or equal to the specific time span.

13. The method of claim 11, further comprising:
determining, by the processor, to transmit the UL transmission without performing arbitration procedure in the event that the time span between the DL information and the UL transmission is scheduled to be less than the specific time span.

14. The method of claim 11, wherein the UL transmission is different from the earliest UL transmission, the earliest UL transmission includes a configured grant-physical uplink shared channel (CG-PUSCH), and the UL transmission includes a dynamic grant-physical uplink shared channel (DG-PUSCH).

15. The method of claim 1, wherein the UL transmission is the earliest UL transmission, the UL transmission includes a dynamic grant-physical uplink shared channel (DG-PUSCH), another UL transmission of the group of time domain overlapped UL transmissions includes a configured grant-physical uplink shared channel (CG-PUSCH).

16. The method of claim 1, wherein the UL transmission is different from the earliest UL transmission, the earliest UL transmission includes a first physical uplink control channel (PUCCH), the UL transmission includes a second PUCCH, and the step of receiving the UL transmission further includes:
receiving the first PUCCH combined with the second PUCCH.

17. The method of claim 1, wherein the UL transmission is the earliest UL transmission, the UL transmission includes a first physical uplink control channel (PUCCH), another UL transmission of the group of time domain overlapped UL transmissions includes a second PUCCH, and the step of receiving the UL transmission further includes:
receiving the first PUCCH combined with the second PUCCH.

18. The method of claim 1, wherein the UL transmission is different from the earliest UL transmission, the earliest UL transmission includes a physical uplink control channel (PUCCH), the UL transmission includes a physical uplink shared channel (PUSCH), and the step of receiving the UL transmission further includes:
receiving the PUSCH including the PUCCH.

19. The method of claim 1, wherein the UL transmission is different from the earliest UL transmission, the earliest UL transmission includes a physical uplink shared channel (PUSCH), the UL transmission includes a physical uplink control channel (PUCCH), and the step of receiving the UL transmission further includes:
receiving the PUCCH included in the PUSCH.

20. An apparatus, comprising:
a transceiver which, during operation, wirelessly communicates with a wireless network; and
a processor communicatively coupled to the transceiver such that, during operation, the processor performs operations comprising:
transmitting, by the transceiver, a downlink (DL) information, wherein the DL information is associated with an uplink (UL) information; and
receiving, via the transceiver, the UL transmission, wherein
in an event that a time span between the DL information and an earliest scheduled UL transmission of a group of time domain overlapped UL transmissions is scheduled to be greater than or equal to a specific time span, a timing of determining the UL transmission of the group of time domain overlapped UL transmissions is before the specific time span ahead of the earliest scheduled UL transmission; or
in an event that a time span between the DL information and the UL transmission is scheduled to be less than the specific time span, the UL transmission is scheduled without collision,
wherein the specific time span is configured to be greater than a required time span between the DL information and the earliest scheduled UL transmission.
